(19) United States
(12) Patent Application Publication
(10) Pub. No.: US 2003/0027606 A1
(43) Pub. Date: Feb. 6, 2003

(54) Wireless earphone having mainframe separated with output unit

(75) Inventor: Chin-Shan Tsai, Hsin-Tien City (TW)

Correspondence Address: BACON & THOMAS, PLLC, 625 SLATERS LANE, FOURTH FLOOR, ALEXANDRIA, VA, 22314

(73) Assignee: Shin Jiuh Corp., Taipei Hsien (TW)

(21) Appl. No.: 09/917,884

(22) Filed: Jul. 31, 2001

(51) Int. Cl. H04M 1/00

(52) U.S. Cl. 455/568; 455/569

(57) ABSTRACT

A wireless earphone with a mainframe separated with an output unit comprises a mainframe having a signal portion having a transmission chip, a message processing unit for bidirectionally receiving/transmitting far-end bidirectional signals; and a positioning unit assembled and clamped in a human body; and an output unit having a voice emitting unit arranged at an ear of the human body and outputting signals, a receiving unit arranged at the speaking portion of the human body and then inputting signal to the message processing unit. The mainframe is separated with the output unit, thereby, the whole weight is reduced so as to provide a comfort feeling to the user.

### BACKGROUND OF THE INVENTION

The present invention relates to a wireless earphone, and particularly to a wireless earphone with a mainframe separated with an output unit, thereby, the whole weight is reduced and thus the user can wear it comfortably.

Currently, mobile phones have become a necessary device for modem people. In many conditions, earphones of handle free receivers are used to make the users use the mobile phone more conveniently. However, the transmission line of an earphone is too long to be convenient. Furthermore, the functions of the earphone are only finite.

To resolve the problem about the inconvenience of the hand free receiver, blue tooth wireless handsets are developed. The blue tooth technology will interconnect handsets, computers, PDA and other products with other telephone or computers. By the blue tooth technology, the handsets, computers, PDAs and fax machines can be integrated in one body. However, currently, blue tooth handsets have many defects.

1. Other than a transmission chip, batteries are necessary for supply power to the mainframe. Furthermore, it is further integrated with earphones and microphone. Therefore, it is too heavy to be hung on the head of the user. To solve this problem, clamping device is developed. However, this device cause a pressure to the head of the user. Especially, for those wearing glasses, this will cause that the legs of the glasses can be hung on the ears for a long time period. Therefore, the use of the product is finite.

2. To have a better voice communication, the mainframe must be adhered to the head of the body, and thus the electromagnetic wave will affect the body of the user.

3. The mainframe cause an invisible part to the user's eyes. Thereby, the blue tooth earphones are purely used in receiving and transmitting signals, but can not display the incoming calling, other functions.

### SUMMARY OF THE INVENTION

Accordingly, the primary object of the present invention is to provide a wireless earphone with a mainframe separated with an output unit, wherein the electromagnetic wave will not affect the shoulders. The improvement is:

1. Since the weight of the mainframe is reduced, the burden to the ear of the human body is reduced greatly. The wearer will not feel tired.

2. Since the shoulders of the human body may suffer from a larger force, other than the original equipment, the mainframe may be installed with a display portion for emitting light or a microphone, or a control portion for controlling the signal receiving/transmitting signal. Therefore, the wireless earphone has more extra functions.

3. The mainframe has a variety of configuration as desired so as to present a beautiful outlook.

To achieve above objects, the present invention provides a wireless earphone with a mainframe separated with an output unit. The present invention comprises a mainframe having a signal portion having a transmission chip, a message processing unit for bidirectionally receiving/transmitting far-end bidirectional signals; and a positioning unit assembled and clamped in a human body; and an output unit having a voice emitting unit arranged at an ear of the human body and outputting signals, a receiving unit arranged at the speaking portion of the human body and then inputting signal to the message processing unit. The mainframe is separated with the output unit, thereby, the whole weight is reduced so as to provide a comfort feeling to the user.

The various objects and advantages of the present invention will be more readily understood from the following detailed description when read in conjunction with the appended drawing.

### BRIEF DESCRIPTION OF THE DRAWINGS

FIG. 1 is a schematic view of the first embodiment of the present invention.

FIG. 2 is a schematic view of the second embodiment of the present invention.

FIG. 3 is a schematic view of the third embodiment of the present invention.

FIG. 4 is a schematic view of an embodiment showing that the present invention is worn on a human body.

### DETAILED DESCRIPTION OF THE PREFERRED EMBODIMENTS

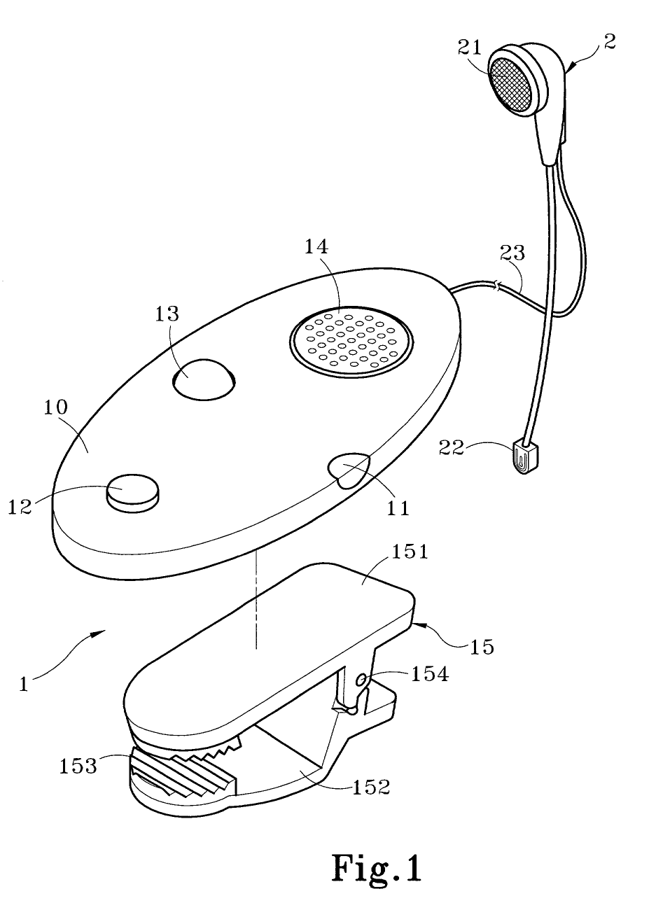

Referring to FIG. 1 the structural exploded view of the present invention showing the present invention being worn on the body is illustrated.

As illustrated in the drawings, The present invention includes a mainframe 1 and an output unit 2 connected to a message processing unit 10 through a transmission line 23. The mainframe 1 includes a signal portion 11 having a transmission chip (not shown), a message processing unit 10 for bidirectionally receiving/transmitting far-end bidirectional signals; and a positioning unit 15 assembled and clamped in a human body 3. The positioning unit 15 has two clamping pieces 151, 152 which are connected by a pivotal piece 154. The front ends of two clamping pieces 151, 152 have claw portions 153 which are symmetrically. The output unit 2 includes a voice emitting unit 21 arranged at an ear of the human body 3 and outputting signals and a receiving unit 22 arranged at the speaking portion 33 of the human body 3 and then inputting signal to the message processing unit 10.

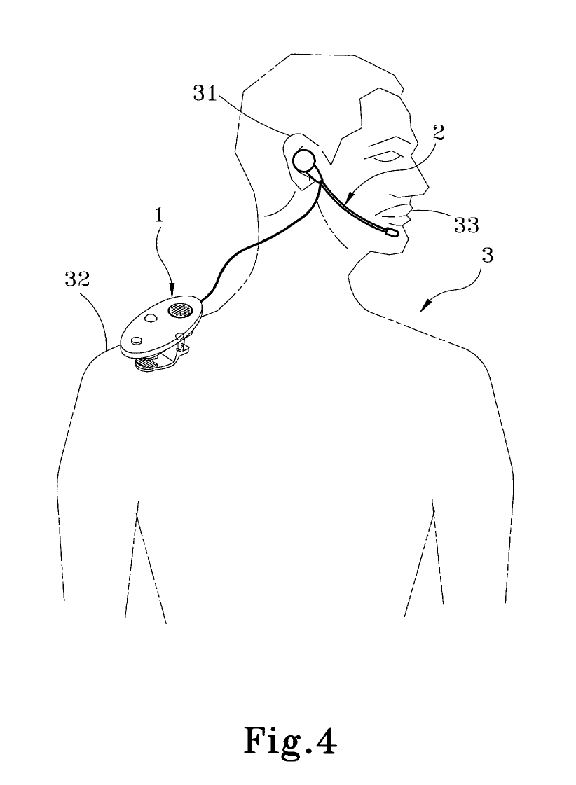

Referring to FIG. 4, the clamping piece 153 of the positioning unit 15 may be clamped to the clothes on the shoulder 32 of the human body 3. Since the length of the transmission line 23 is shorter, it will not wind improperly due to rotation of the head. Since the shoulders 32 of the human body 3 may suffer from a larger force, other than the original equipment, the mainframe 1 may be installed with a display portion 13 for emitting light or a microphone 14, or a control portion 12 for controlling the signal receiving/transmitting signal. Therefore, the wireless earphone has more extra functions. The transmission line 23 is used to connect a pivotal unit. Since the weight of the mainframe 1 is reduced, the burden to the ear 31 of the human body 3 is reduced greatly. The wearer will not feel tired. Furthermore, the user may wear a pair of glasses without being affected by the present invention. Moreover, the mainframe 1 has a variety of configuration as desired so as to present a beautiful outlook.

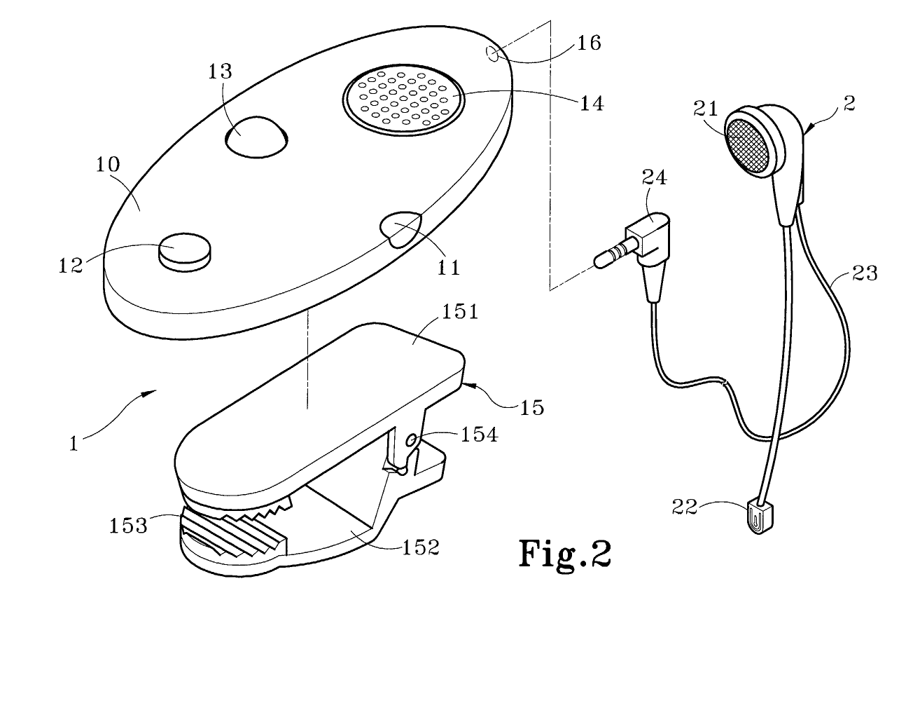

FIG. 2 shows a schematic view of the second embodiment of the present invention. To increase the application of the present invention, the message processing unit 10 is installed with a receptacle 16 which is conformable to the plug 24 at the end portion of the transmission line 23. If the output unit 2 is damaged due to a mistake, it may be updated by a lower cost. The output unit 2 may be replaced by a hand free earphone conformable to a current mobile phone. Therefore, the cost is saved.

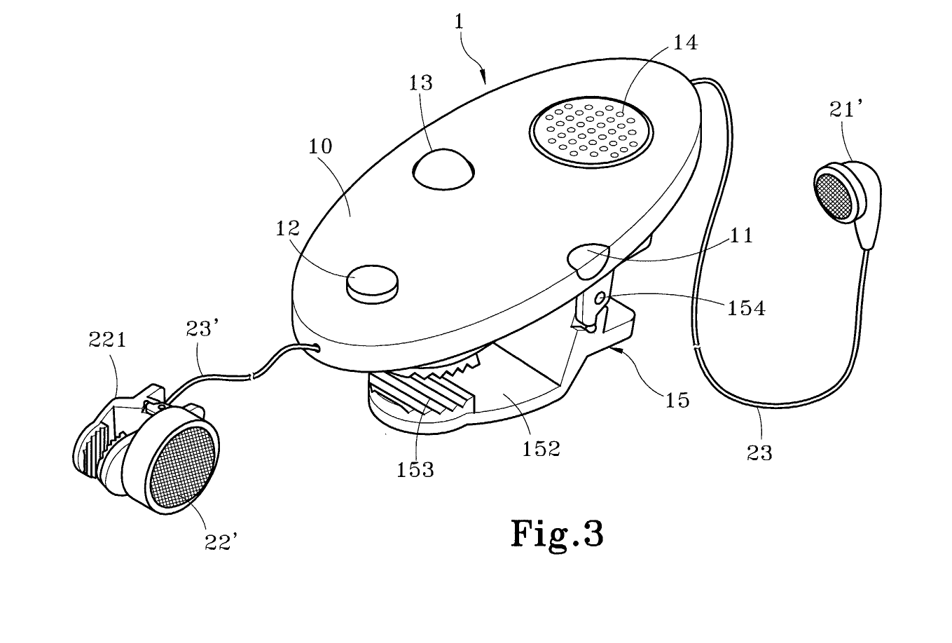

A schematic view of the third embodiment of the present invention is illustrated in FIG. 3. To further reduce the burden to the ear 31 of the human body 3, and adjust the present invention responsive to the speaking portion 33 of the user, the voice emitting unit 21′ and the receiving unit 22′ of the output unit 2 may be connected to the message processing unit 10 by respective transmission line 23, 23′. Another positioning unit 221 is assembled to the receiving unit 22′. Therefore, the user may select the wearing position of the receiving unit 22′. Therefore, the application of the present invention can be expanded.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wireless earphone with a mainframe separated with an output unit comprising:
a mainframe having a signal portion having a transmission chip,
a message processing unit for bidirectionally receiving/transmitting far-end bidirectional signals; and a positioning unit assembled and clamped in a human body; and
an output unit having a voice emitting unit arranged at an ear of the human body and outputting signals, a receiving unit arranged at the speaking portion of the human body and then inputting signal to the message processing unit through a transmission line;
wherein the mainframe is separated with the output unit, thereby, the whole weight is reduced so as to provide a comfort feeling to the user.

2. The wireless earphone with a mainframe separated with an output unit as claimed in claim 1, wherein the message processing unit is further installed with a display portion for informing incoming message to the user.

3. The wireless earphone with a mainframe separated with an output unit as claimed in claim 1, wherein the message processing unit is further installed with a microphone for informing incoming message to the user.

4. The wireless earphone with a mainframe separated with an output unit as claimed in claim 1, wherein a control portion for controlling the signal receiving/transmitting signal is installed at the message processing unit.

5. The wireless earphone with a mainframe separated with an output unit as claimed in claim 1, wherein the positioning unit has two clamping pieces which are connected by a pivotal piece; front ends of two clamping pieces have claw portions which are symmetrically.

6. The wireless earphone with a mainframe separated with an output unit as claimed in claim 1, wherein the message processing unit is installed with a receptacle which is conformable to a plug at an end portion of the transmission line.

7. The wireless earphone with a mainframe separated with an output unit as claimed in claim 1, wherein the voice emitting unit and the receiving unit of the output unit are connected to the message processing unit by respective transmission line.
